(19) United States
(12) Patent Application Publication
(10) Pub. No.: US 2005/0055401 A1
(43) Pub. Date: Mar. 10, 2005

(54) Newspaper system with remote updating and printing

(76) Inventor: Nicholas J. Helmer II, Woodstock, IL (US)

Correspondence Address: Nicholas J. Helmer, II, Suite 202, 188 North Wells Street, Chicago, IL, 60606, US

(21) Appl. No.: 10/786,880

(22) Filed: Feb. 25, 2004

Related U.S. Application Data
(60) Provisional application No. 60/451,211, filed on Feb. 28, 2003.

(51) Int. Cl. G06F 15/16

(52) U.S. Cl. 709/204

(57) ABSTRACT

An electronic system for distributing up to date news information to patrons includes central news facilities receiving current news information. A number of newspaper machines are located remote from the central news facilities and communicate with them via wireless transmission or a network. Patrons insert payment into the remote newspaper machines and the machines are updates from the central news facilities. The patrons may select specific portions of the newspaper to print. After a patron has inserted payment and the newspaper machine has been updated, the specific portion of the newspaper selected by the patron is printed.

### CLAIM OF PRIORITY

This application claims priority from U.S. Provisional Patent Application Ser. No. 60/451,211 filed Feb. 28, 2003, currently pending.

### BACKGROUND OF THE INVENTION

The present invention relates generally to newspaper production and distribution systems and, more particularly, to a newspaper system that updates and prints newspapers via a machine that is located remotely from a central news facility.

There are several disadvantages with conventional newspaper production and distribution systems and the information contained in the newspapers provided by such systems. Perhaps the most significant is that a conventional newspaper quickly becomes outdated. In addition, conventional newspapers cannot be tailored to an individual reader's specific interests. More specifically, a newspaper may feature several sections or articles that a reader cares nothing about. Furthermore, conventional newspapers are cumbersome to read and carry. Conventional newspapers also provide a great deal of waste in that many discarded papers are not recycled. In addition, waste occurs when copies of conventional newspapers are unsold. A need thus exists for a newspaper production and distribution system that overcomes these disadvantages.

Prior art systems have taken advantage of recent advances in computer and communications technologies in attempts to overcome the disadvantages of conventional newspaper distribution systems. For example, U.S. Pat. No. 5,970,231 to Crandall illustrates a system that transmits news data or electronic publications from a central news facility to multiple remote stations (referred to as “base stations” or “base units”). The base unit of the Crandall '231 patent includes an internal storage that contains the electronic publications downloaded from the central news facility. The base units periodically receive updated versions of the electronic publications. A portable “electronic newspaper” is removably positioned within a base unit. The electronic newspaper includes a screen through which a user may view a list of available electronic publications. When a user selects an electronic publication, the electronic publication is transferred from the base unit to the memory of the electronic newspaper. The base unit also includes an infrared port that may communicate with a wireless printer so that the selected publications may be printed.

Commercial versions of the base unit of the Crandall '231 patent may be placed with commercial vendors such as supermarkets, convenience stores, sundry shops, airport shops, bookstores and any other retail establishment that would sell publications on a single issue basis. With such an arrangement, a customer enters a store and places their electronic newspaper unit on the store's base unit and enters a PIN number. The customer selects from the list of publications that are displayed upon the screen of the electronic newspaper and then selects a debit or credit card to consummate the transaction. The purchased publications are downloaded into the electronic newspaper unit. The customer then removes the electronic newspaper unit from the base unit so that the downloaded publications may be read when and where the customer pleases.

A disadvantage of the system of the Crandall '231 patent, however, is that the updates are performed periodically at set time intervals. More specifically, the publications are downloaded as they are released by their publishers. As a result, there will always be some time lag between the time that the base unit receives an update and the time that a user downloads or prints the publication.

U.S. Pat. No. 5,845,262 to Nozue et al. discloses a vending machine for electronic news information. The machine is installed at a location where people meet such as at a station or on a street. News is transmitted from a central news source to the vending machines through a satellite link or terrestrial line. When the patron purchases the electronic news information by inserting cash or other form of payment into the machine., the information is recorded from the machine onto a recording medium such as a computer disk or removable IC chip. The information recorded on the recording medium may be read by a personal computer or the like.

The news information stored on the machine of the Nozue et al. '262 patent is automatically updated so, for example, the evening edition of a newspaper is transmitted to the machine in the evenings and the morning edition of the newspaper is transmitted to the machine in the morning. While the system of the Nozue et al. '262 patent does provide updates from a central facility to remote machines, the updates are, once again, performed at set time intervals instead of being dictated by consumer purchases.

U.S. Pat. No. 5,630,103 to Smith et al. illustrates a system for electronically transmitting news information from a central source via radio frequencies to subscriber reception stations. The received news information may be displayed upon a computer screen or printed out by the subscriber. The updates are, similar to the above prior art systems, provided at the discretion of the central source and not the subscriber.

Accordingly, it is an object of the present invention to provide a newspaper system that provides printed publications that are updated when a patron makes a purchase request.

It is another object of the present invention to provide a newspaper system that permits a patron to select an updated newspaper for purchase from a number of available newspapers.

It is another object of the present invention to provide a newspaper system that permits a patron to select specific updated sections or articles (e.g. sports, weather, local or world news, etc.) from newspapers for purchase.

It is still another object of the present invention to provide a newspaper system that permits a patron to select updated headline articles from specified geographic regions of the world for purchase.

It is still another object of the present invention to provide a newspaper system that is efficient and economical to operate.

It is still another object of the present invention to provide a newspaper system that reduces waste in terms of discarded and unsold newspapers.

The following detailed description of embodiments of the invention, taken in conjunction with the accompanying drawings, provide a more complete understanding of the nature and scope of the invention.

### SUMMARY OF THE INVENTION

An electronic system for distributing up to date news information to patrons includes a central news facility receiving current news information. A newspaper machine located remote from the central news facility and in communication with the central news facility accepts payment from and provides news information to the patrons. The central news facility transmits the current news information to the newspaper machine when the patrons request news information from the remote newspaper machine by inserting payment.

The newspaper machine prints out the updated news information transmitted from said central news facility. The newspaper machine permits patrons to select portions of the updated news information to print out. Patrons may also select the size of newsprint and language within which to print out the news information. The newspaper machine also includes means for accepting newspaper pages and means for providing a recycle credit to a patron for every newspaper page fed into the newspaper machine by the patron.

For a more complete understanding of the nature and scope of the invention, reference may now be had to the following detailed description of embodiments taken in conjunction with the appended claims and accompanying drawings.

### BRIEF DESCRIPTION OF THE DRAWINGS

FIG. 1 is a schematic illustrating the main components of an embodiment of the newspaper system of the present invention;

FIG. 2 is a perspective view of a remote machine suitable for use with the newspaper system of the present invention;

FIGS. 3A-3C are flow diagrams illustrating the screens that are displayed on the remote machine of FIG. 2.

### DESCRIPTION OF THE PREFERRED EMBODIMENTS

It is to be understood that while the present invention is described below in terms of printing out publications such as newspapers, articles and the like, the invention could be adapted to download the news information to a portable computing device such as a palm-sized computer or personal organizer.

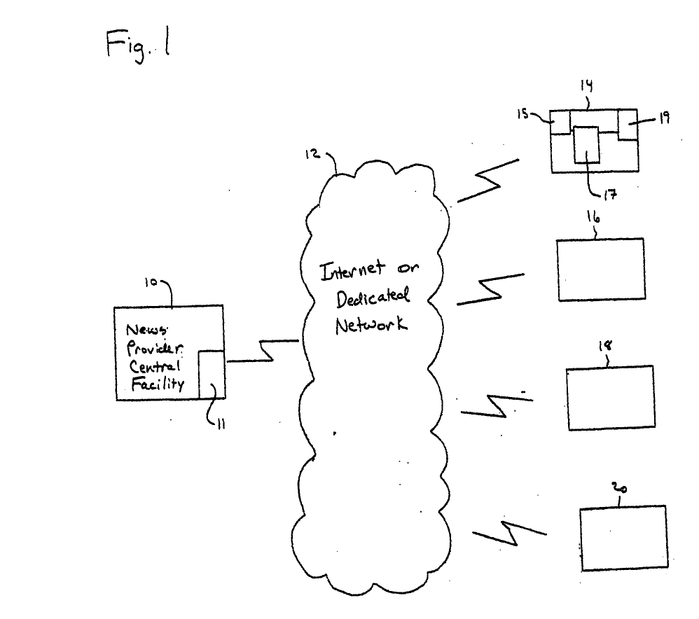

The invention is a system for providing printed “up to the minute” newspapers to the public. The system is also efficient in that it there is reduced paper waste and the newspaper, since it only contains information that the purchaser has requested, is more convenient to carry. With reference to the FIG. 1, the news provider receives updates for specific geographic location or paper through its reporters, new wires, etc. at its central facility 10. The updates are entered into a central facility computer 11. Any type of data storage and transmission device could be substituted for the computer 11 of FIG. 1.

The central facility computer 11 communicates with remote newspaper machines 14, 16, 18 and 20 through the Internet or a dedicated network 12. The communications between computer 11 and machines 14 through 20 may take place through the Internet or dedicated network 12 via wire connections, such as through a telephone jack, or wireless transmissions. In the case of the latter, a transmitter is in communication with the central facility computer 11 while each machine 14 through 20 includes a compatible receiver, such as illustrated at 15. Each machine also contains computer memory, as illustrated at 17, that is in communication with the receiver. The computer memory 17 contains the publications and updates received from the central facility through the network 12. As a result, each machine 14 through 20 has access to the latest news developments.

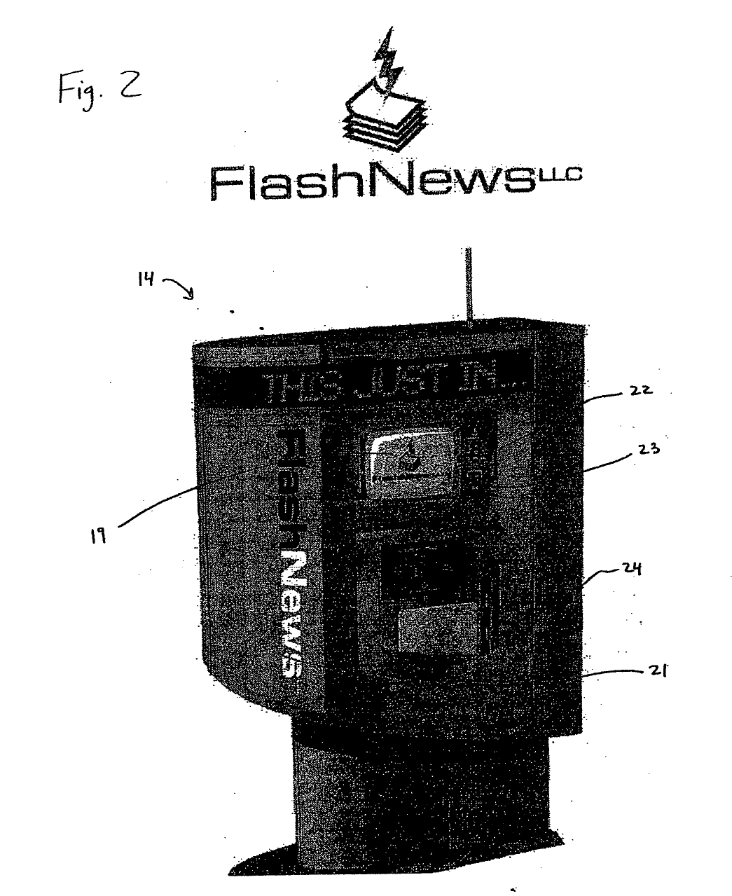

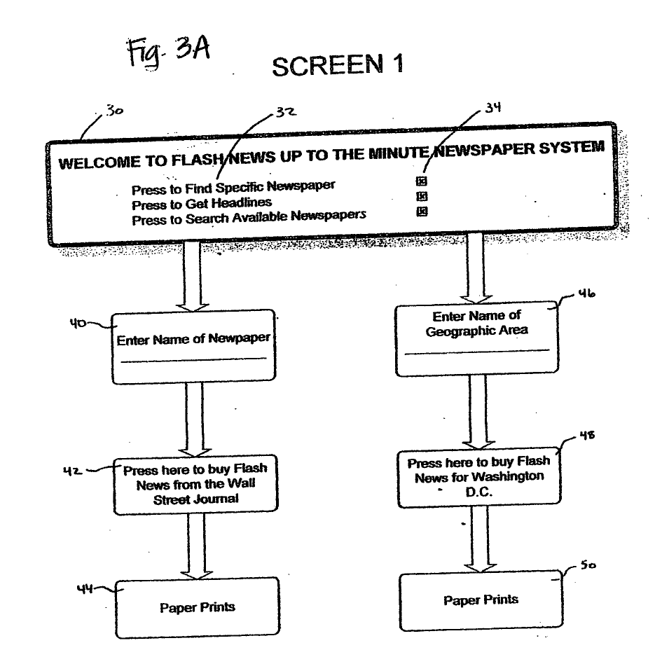

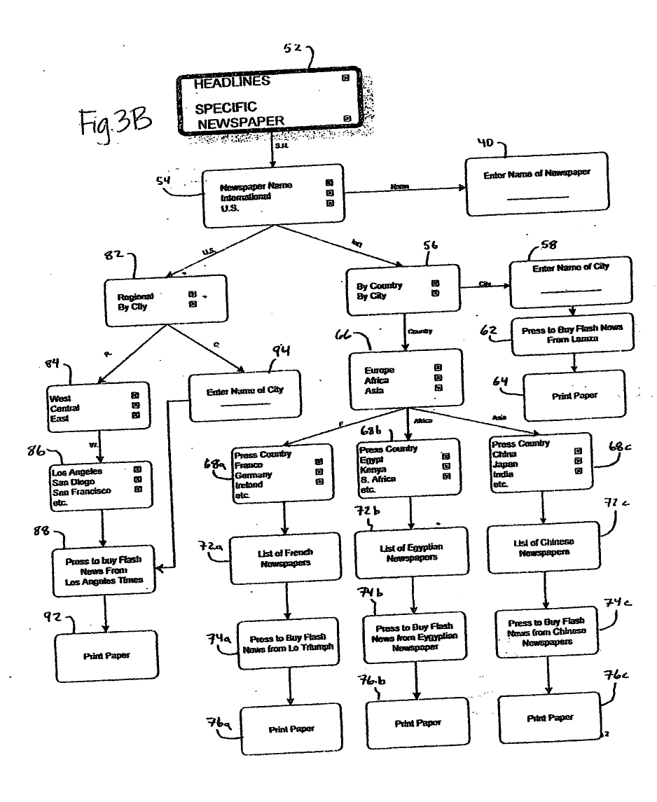

As illustrated in FIG. 2, each machine 14 through 20 is sized approximately the size of a current corner newspaper sales box or an automated teller machine (ATM) and is positioned in a public place. Such public places could include, for example, coffee shops, grocery stores, office buildings, near mass transit such as airports or train stations, restaurants, waiting rooms, etc.). Using machine 14 as an example, each machine includes a display 19, a high speed printer 21, an input device, such as a keypad 22, and a means to accept payment from a customer 23, such as mechanisms to accept currency or credit cards. As will be explained below, when a customer provides payment to a machine and makes his or her selection, the machine prints out an updated newspaper, article or the like. More specifically, the newspaper, article or the like is instantly updated and printed when a customer orders his paper by inserting their payment into the machine.

As an alternative to entering currency or a credit or debit card, the customer may have an account set up with the news provider whereby the customer merely needs to enter an account number or other user identification code so that the purchase is billed to his or her account. As yet another alternative, the customer could purchase a “rechargeable” card that is inserted into the machine when the customer wishes to make a purchase. The card would feature a magnetic strip, as is known in the art, upon which an available balance is recorded. The balance would be reduced by an appropriate amount when the customer makes a purchase. The balance available on the card would be increased, that is, the card would be recharged, by inserting the card into a recharging station and inserting money into the station.

The machine 14 of FIG. 2 could optionally include a recycle slot, indicated at 24. Such a slot would receive newspaper pages that a patron would otherwise discard (after reading, for example) for recycle credit. That is, after entering his or her account information or inserting his or her card into the machine 14, the account or card would receive a “recycle credit” for each page entered through slot 24. Alternatively, the machine could indicate that a certain monetary amount has been entered into the machine for every page that is directed through slot 24. Pages fed through slot 24 would be collected in a bin inside the machine, or in some other fashion, which would periodically be emptied by the machine owners. As a result, the system of the present invention would encourage recycling and thus reduce waste even further.

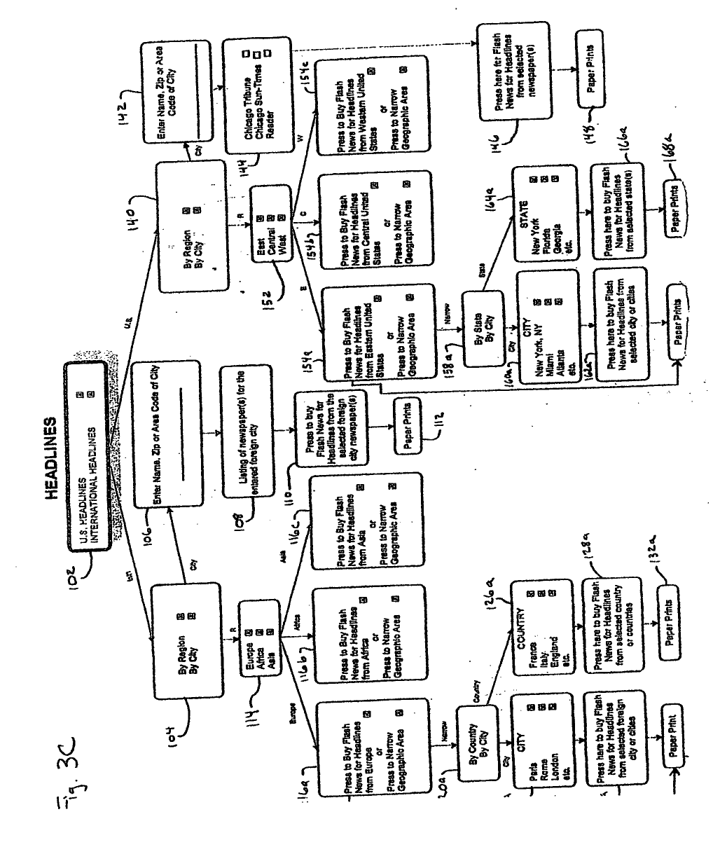

FIGS. 3A through 3C illustrate sample screens that may be displayed upon the screen 19 of machine 14 of FIG. 2 to guide a customer through selecting, purchasing and printing newspapers, articles and the like. It should be noted that the screens and flow diagrams are presented as examples only and in no way should they be construed to limit the scope of the present invention. With reference to FIG. 3A, when a customer approaches the machine, screen 30 is displayed. If a credit or debit card or account number payment system is used, the screen 30 could be displayed when the customer input his or her card, account number or user id.

Prior to display of screen 30, the system optionally prompts the customer as to what language the screens should feature. In addition or alternatively, the system optionally provides the customer with a print size option. For example, the system could offer the customer three print size choices: standard, enlarged or extra enlarged print size. This would be a beneficial features for senior customers or customers with special vision requirements.

As illustrated at 30, the customer initially has three choices: Find Specific Newspaper, Get Headlines or Search Available Newspaper. As with the remaining screens described below, the user may make his or her selection in a number of alternative fashions. For example, the screen may be touch-sensitive so that the user may press the text 32 or the boxes 34 to make the selection. Alternatively, the keypad 22 of FIG. 2 may feature up and down arrows and enter or select keys so that the customer may toggle between the selections and highlight the appropriate text 32 or check the appropriate box 34. As an alternative to the keypad 22 of FIG. 2, a touch-sensitive keypad could be displayed on the screen 19 of the remote machine 14 (FIG. 2).

If the customer selects Find Specific Newspaper from screen 30, screen 40 is displayed. The customer enters the name of the newspaper in screen 40 using the keypad 22 (FIG. 2), and, if the newspaper is available, screen 42 is displayed. If the newspaper is not available, a suitable message is displayed instead and the customer is returned to screen 40. The message displayed may optionally provide access to an electronic request form that the customer may send electronically (such as via e-mail) to the requested newspaper suggesting that it be added to the system. Alternatively, the system could automatically send an e-mail message to the requested paper advising that their paper has been requested but is not available on the system. As a result, newspaper publishers would contact the owner of the system and request that their paper be added.

As an alternative to typing the name of the newspaper into screen 40, in an alternative embodiment of the system, the customer could select from a list of newspapers that are presented on screen 40. In such an embodiment, screen 40 could offer access to an electronic request form of the type described in the above paragraph in the event that the customer does not see the desired newspaper listed.

If the customer presses the screen or appropriate key when screen 42 is displayed, the selected newspaper is instantly updated in the memory of the machine (17 in FIG. 1) via a transmission from the central facility if a credit or debit card or account number was entered previously. The customer's account will also be charged. If the customer has not entered such information previously, he or she will be prompted to enter payment upon pressing or otherwise electing to proceed when screen 42 is displayed. Only upon entry of payment will the selected newspaper be instantly updated in the memory of the remote machine. Once the machine has received payment, in one form or another, and the newspaper has been immediately updated in the remote machine memory, the newspaper will print, as indicated at 44.

For the sake of brevity, the remaining portion of the discussion will assume that a credit or debit card or other account information has been entered by the customer prior to, or immediately after, the display of screen 30. It is to be understood, however, that if this were not the case, payment would have to be entered into the machine prior to the machine being remotely updated and the newspaper, article or the like printing out.

If the customer instead selects Get Headlines when screen 30 is displayed, screen 46 will be displayed. The Geographic Area requested by screen 46 could take on a number of forms. For example, it could be a country, continent, state, region (i.e. Northwest or South of France) or other geographic division. Assuming that Washington D.C. was entered into screen 46, screen 48 would be displayed. If screen 48 were selected by touch screen or keypad, the headlines for Washington D.C. would be instantly updated in the machine memory via transmission from the central facility (10 in FIG. 1), the customer's account would be charged and a number of headline articles for the selected geographic area (Washington D.C. in this case) would be printed out as indicated at 50.

If the customer, upon encountering screen 30, selects Search Available Newspapers, screen 52 of FIG. 3B is displayed. If the customer selects Specific Newspaper from screen 52, screen 54 is displayed. From screen 54, the customer may select a specific Newspaper Name or, alternatively, he or she may choose between International or U.S. newspapers. If the customer chooses Newspaper Name, screen 40 of FIG. 3A is displayed. Upon entry of the name of the newspaper, processing continues as described above with regard to screens 42 and 44 of FIG. 3A.

If the customer chooses International newspapers from screen 54, screen 56 is displayed. Screen 56 allows the customer to choose between selecting a Country or City. If the latter is chosen, screen 58 is displayed, which prompts the customer for the name of the foreign city. Upon entering the name of the city, the name of the city newspaper is displayed as indicated at 62. If the city features more than one newspaper, than a list of the city newspapers is displayed and the customer proceeds by selecting a newspaper from the list. Once the specific city newspaper is selected, it is immediately updated and then printed as indicated at 64.

If the customer chooses Country from screen 56, screen 66 is displayed. This screen permits the customer to select a continent. If Europe is selected, a list of European countries is displayed as indicated at 68a. The customer then selects a country from the list, France for example, and a list of French newspapers is displayed as indicated at 72a. Upon selecting a newspaper from the list, the customer is prompted to purchase the newspaper at 74a. If the customer elects to purchase the newspaper by an affirmative response to screen 74a, the newspaper, Le Triumph for example, is updated (via transmission from the central facility to the remote machine and its memory) and then printed out as indicated at 76a. Similar actions take place as indicated at 68b through 76b and 68c through 76c if alternative continents are selected from screen 66. It should be noted that additional continents, such as Central America and South America, could be added to the listing of display 66.

Returning to screen 54, if the U.S. newspapers option is selected instead of the Newspaper Name and the International newspapers option, screen 82 is displayed. Screen 82 permits the customer to select between choosing a newspaper by Region or City. If Regional is selected, a listing of regions is provided as illustrated at 84. While West, Central and East are shown at 84, it should be noted that alternative regional groupings could be used, for example, North, South, Midwest, etc.

As illustrated at 86, the major cities for a region, West for example, are listed when the region is selected by the customer from screen 84. When a city, Los Angeles for example, is selected from the list of screen 86, the customer is given the option to purchase the newspaper via screen 88. If the city has more than one newspaper, a list of newspapers is displayed to the customer instead and, upon selection of one of the newspapers, screen 88 is displayed. Upon electing to purchase the newspaper by an affirmative response to screen 88, the newspaper is updated in the remote machine's memory via transmissions from the central facility and is printed out as indicated at 92. Of course, screens similar to screens 86, 88 and 92 are displayed if an alternative region is selected from screen 84.

If By City is selected from screen 82, screen 94 is displayed. Upon entry of the city name in response to screen 94, either screen 88 is displayed (listing the appropriate newspaper) or a list of available newspapers for the city is displayed. In the latter case, screen 88 is displayed when a newspaper is selected from the list. The paper is updated and printed, as indicated at 92, upon entry of an affirmative response to screen 88 by the customer.

FIG. 3C illustrates the screens that are displayed when Headlines are selected from screen 52 of FIG. 3B. More specifically, when Headlines are selected from screen 52 of FIG. 3B, screen 102 of FIG. 3C is displayed. If the customer selects International Headlines from screen 102, screen 104 is displayed. At this point, the customer may choose to receive headline articles from a region or a city. If the latter is selected, screen 106 is displayed. Upon entering the foreign city name, a listing of newspapers is presented, as indicated at 108. The customer may then elect between receiving headline news articles from one, some or all of the city newspapers listed on screen 108. The elections may be made by electronically checking boxes, highlighting the newspaper name(s) or other user interface methods well-known in the art. Once the newspaper selections are made in screen 108, screen 110 is displayed at which time the customer may elect to purchase the headline articles from the selected papers. If the customer proceeds by responding affirmatively, the headline articles are updated and printed, the latter of which is indicated at 112.

If Region is selected from screen 104, screen 114 is displayed. Screen 114 allows the customer to choose between continents from which to receive headline news articles. It should be noted that additional continents, such as South America, etc. may also be listed on screen 114. When one of the continents is selected, either screen 116a, 116b or 116c is displayed.

Assuming that Europe is selected from screen 114, screen 116a is displayed. When screen 116a is displayed, the user has the option of printing out the current headline news articles for that continent. It is obviously impractical and redundant to update and print headline news articles for all of the major papers of a continent. As such, the news provider may create or otherwise provide a continent-specific headline newspaper that contains a collection of major headline news articles for a continent. The continent-specific headline newspaper would then be updated and printed (118a) if the customer so elects when screen 116a is displayed.

If the customer elects to narrow the Geographic Area down from an entire continent, he or she may so choose from screen 116a. When this occurs, screen 120a is displayed. Screen 120a allows the customer to choose between receiving current headline news articles from cities for the continent of screen 116a or for entire countries of the continent of screen 116a. If the customer chooses By City from screen 120a, screen 122a is displayed. Screen 122a lists the major cities for the continent. The customer may select one, some or all of the cities listed on screen 122a It would be impractical and redundant to update and print out headline news articles for all of the papers for each city selected from screen 122a. As such, the news provider creates or otherwise provides a city-specific headline newspaper for each of the cities listed on screen 122a that contains a collection of headline news articles for the city. The appropriate city-specific headline newspapers are immediately updated and printed (I 18a) when the customer so elects by providing an affirmative response to screen 124a. Of course, if a selected city only has one major newspaper, headline news articles may be printed from that major paper instead of the news provider creating a special city-specific headline newspaper.

If By Country is selected from screen 120a, screen 126a is displayed. From screen 126a, the customer may select one or more of the countries of the continent selected from screen 114. Upon entering the country selections from screen 126a, screen 128a is displayed. By responding affirmatively to screen 128a, the customer elects to update and print (132a) the headline news articles for the countries selected in screen 126a. As with the printouts received from screens 16a and 124a, it is impractical and redundant to update and print headline news articles for all of the major papers of a country. As such, the news provider may create or otherwise provide a country-specific headline newspaper that contains a collection of major headline news articles for a country. The appropriate country-specific headline newspapers are updated and printed when an affirmative response is provided to screen 128a.

Screens 116b and 116c work in the same fashion as screen 116a. In addition, screens corresponding to screens 118a through 132a would be provided as screens that could be accessed from screens 116b and 116c. Such screens, if illustrated in FIG. 3C, would be numbered 118b through 132b and 118c through 132c, respectively.

Returning to screen 102 of FIG. 3C, a customer may elect to receive headline news articles for the U.S. instead of International. By electing U.S. Headlines from screen 102, screen 140 is displayed. From screen 140, the customer may choose between receiving U.S. news headlines for a region or city. If the latter is chosen, screen 142 is displayed.

Upon entering the city name in screen 142, for example Chicago, a listing of newspapers is presented via screen 144. The customer may then elect between receiving headline news articles from one, some or all of the city newspapers listed on screen 144. Once the newspaper selections are made in screen 144, screen 146 is displayed at which time the user may elect to purchase the headline articles from the selected papers. If the customer proceeds by responding affirmatively, the headline articles are updated and printed, the latter of which is indicated at 148.

If Region is selected from screen 140, screen 152 is displayed. Screen 152 allows the customer to choose between U.S. regions from which to receive current headline news articles. It should be noted that alternative or additional regions, such as the Midwest, etc. may be listed on screen 152. When one of the regions is selected, either screen 154a, 154b or 154c is displayed.

Assuming that East is selected from screen 152, screen 154a is displayed. When screen 154a is displayed, the user has the option of printing out the headline news articles for that region. It is obviously impractical and redundant to update and print headline news articles for all of the major papers of a region. As such, the news provider may create or otherwise provide a region-specific headline newspaper that contains a collection of major headline news articles for a region. The region-specific headline newspaper would then be updated and printed (156a) if the customer so elects when screen 154a is displayed.

If the customer elects to narrow the Geographic Area down from an entire region, he or she may so choose from screen 154a. When this occurs, screen 158a is displayed. Screen 158a allows the customer to choose between receiving headline news articles from cities for the region of screen 154a or for entire states of the region of screen 154a. If the customer chooses By City from screen 158a, screen 160a is displayed. Screen 160a lists the major cities for the region. The customer may select one, some or all of the cities listed on screen 160a. It would be impractical and redundant to update and print out headline news articles for all of the papers for each city selected from screen 160a. As such, the news provider creates or otherwise provides a city-specific headline newspaper for each of the cities listed on screen 160a that contains a collection of headline news articles for the city. The appropriate city-specific headline newspapers are updated and printed (156a) when the customer so elects by providing an affirmative response to screen 162a. Of course, if a selected city only has one major newspaper, headline articles may be printed from that major paper instead of the news provider creating a special city-specific headline newspaper.

If By State is selected from screen 158a, screen 164a is displayed. From screen 164a, the customer may select one or more of the states of the East region. Upon making and entering the state selections from screen 164a, screen 166a is displayed. By responding affirmatively to screen 166a, the customer elects to update and print (168a) the headline news articles for the states selected in screen 164a. As with the printouts received from screens 154a and 162a, it is impractical and redundant to update and print headline news articles for all of the major papers of a state. As such, the news provider may create or otherwise provide a state-specific headline newspaper that contains a collection of major headline news articles for a state. The appropriate state-specific headline newspapers are updated and printed when an affirmative response is provided to screen 166a.

Screens 154b and 154c work in the same fashion as screen 154a. In addition, screens corresponding to screens 156a through 168a would be provided as screens that could be accessed from screens 154b and 154c. Such screens, if illustrated in FIG. 3C, would be numbered 156b through 168b and 156c through 168c, respectively.

While FIGS. 3A-3C illustrate only newspapers or headline articles, it should be noted that systems that permit updated sections or other types of articles for printing at the remote machines are within the scope of the present invention. Such capability could be added, for example, by adding screens listing the sections or articles of a newspaper after the name of the newspaper is entered in screen 40 of FIGS. 3A and 3B.

The only regular maintenance that is required for the remote newspaper machines 14 through 20 of FIG. 1 is refilling the paper and toner, a task that may be completed by the same people that refill the current machines with newspapers. The news provider that owns the machines may monitor each machine via the communications link 12 so that when a machine needs service, they will know instantly.

The system of the present invention also offers an additional source of revenue through the sale advertising. For example, advertising could be printed on the back sides of pages produced byt the machine 14 of FIG. 2. Such advertising could include, for example, coupons that the patron could take to the store being advertised. In addition, advertising space on the machine itself, in the form of signs or banners, for example, could be sold. The machines themselves could also offer a revenue stream by being leased to the location where they are placed. For example, a coffee shop could lease a machine from the system owner. Alternatively, the machines could be sold by the system owner.

While the preferred embodiments of the invention have been shown and described, it will be apparent to those skilled in the art that changes and modifications may be made therein without departing from the spirit of the invention.

1. An electronic system for distributing up to date news information to patrons comprising:
a. a central news facility receiving current news information;
b. a newspaper machine located remote from the central news facility and in communication with the central news facility, said remote newspaper machine accepting payment from and providing news information to the patrons; and
c. said central news facility transmitting the current news information to said newspaper machine when the patrons request news information from the remote newspaper machine.

2. The system for distributing news of claim 1 wherein said newspaper machine prints out the updated news information transmitted from said central news facility.

3. The system for distributing news of claim 2 wherein the newspaper machine permits patrons to select portions of the updated news information to print out.

4. The system for distributing news of claim 2 wherein the newspaper machine permits patrons to select a print size within which to print out the updated news information.

5. The system for distributing news of claim 2 wherein the newspaper machine permits patrons to select a language within which to print out the updated news information.

6. The system of claim 1 wherein the updated news information is transmitted from the central news facility to the newspaper machine via wireless transmission.

7. The system of claim 1 wherein the updated news information is transmitted from the central news facility to the newspaper machine via a network.

8. The system of claim 1 wherein the updated news information is transmitted from the central news facility to the newspaper machine via the Internet.

9. The system of claim 1 wherein the newspaper machine includes means for accepting newspaper pages and means for providing a recycle credit to a patron for every newspaper page fed into the newspaper machine by the patron.

10. The system of claim 1 wherein a patron requests news information from the remote newspaper machine by providing payment.

11. The system of claim 10 wherein the newspaper machine accepts a rechargeable card for payment.
